(19) United States
(12) Patent Application Publication
(10) Pub. No.: US 2010/0131333 A1
(43) Pub. Date: May 27, 2010

(54) METHOD AND SYSTEM FOR PRODUCT SERVICES ANALYSIS AND OPTIMIZATION

(76) Inventors: Keith Ball, San Jose, CA (US); Shay Donovun Smart, Sausalito, CA (US)

Correspondence Address: Robert D. Shedd, Patent Operations;THOMSON Licensing LLC, P.O. Box 5312, Princeton, NJ, 08543-5312, US

(21) Appl. No.: 12/452,815

(22) PCT Filed: Aug. 6, 2008
(86) PCT No.: PCT/US08/09421

§ 371 Date: Jan. 22, 2010

Related U.S. Application Data
(60) Provisional application No. 60/963,591, filed on Aug. 6, 2007.

(51) Int. Cl. G06Q 10/00; G06Q 30/00

(52) U.S. Cl. 705/10; 705/7

(57) ABSTRACT

Embodiments of the present invention provide a method, apparatus and system for analysis and optimization of product services including at least collecting information regarding at least a definition of a media content campaign and a performance of the media content campaign, and compiling the collected information for analysis, wherein the analysis determines the effectiveness of the media content campaign. In addition, historical, systemic or endemic marketing, merchandising, sales, and operational data about intended products or services to be advertised & promoted in the campaign are provided to a system where the system combines this with other campaign independent data and performs analysis that results in a recommendation (or set of recommendations) on what is needed to effectively execute the campaign.

### FIELD OF THE INVENTION

The present invention generally relates to product services and, more particularly, to a method, apparatus and system for the analysis and optimization of product services.

### BACKGROUND OF THE INVENTION

Before a campaign is started, it may be desirable for a customer to request a system analysis of a product or service to be advertised on one or more out of home mediums, such as retail digital media networks, outdoor signage networks, or another type of venue's digital or signage media network. Currently there are no effective systems or methods for comprehensive analysis of product services.

### SUMMARY OF THE INVENTION

Embodiments of the present invention address the deficiencies of the prior art by providing a method and system for providing analysis and optimization of product services.

In various embodiments of the present invention, historical, systemic or endemic marketing, merchandising, sales, and operational data about intended products or services to be advertised & promoted in the campaign are provided to a system. The system combines this with other campaign independent data and performs analysis that results in a recommendation (or set of recommendations) on what is needed to effectively execute the campaign.

In one embodiment of the present invention, a method in a content distribution system includes collecting information regarding at least a definition of a media content campaign and a performance of the media content campaign in the content distribution system and compiling the collected information for analysis, where the analysis determines the effectiveness of the media content campaign.

In an alternate embodiment of the present invention, an apparatus in a content distribution system includes a memory for storing information regarding at least a definition of a media content campaign and performance information of the media content campaign in the content distribution system, and a processor for collecting the information regarding at least a definition of a media content campaign and a performance of the media content campaign and compiling the collected information for analysis. In such an embodiment, the processor can be further configured to analyze the compiled information to determine an effectiveness of the media content campaign and further provide a recommendation (or set of recommendations) on what is needed to effectively execute the campaign.

In an alternate embodiment of the present invention, a system, includes at least one source of media content, at least one means for receiving a media content campaign definition, and a content distribution system including at least an apparatus. The apparatus can include a memory for storing information regarding at least a definition of the media content campaign and performance information of the media content campaign in the content distribution system and a processor for collecting said information regarding at least a definition of a media content campaign and a performance of the media content campaign and compiling the collected information for analysis. In such an embodiment, the processor can be further configured to analyze the compiled information to determine an effectiveness of the media content campaign and further provide a recommendation (or set of recommendations) on what is needed to effectively execute the campaign.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a content distribution system in which an embodiment of the present invention can be applied;

FIG. 2 depicts a high level block diagram of an in-store advertising network for providing in-store advertising;

FIG. 3 depicts a high level flow diagram of a method for product services analysis and optimization in accordance with one embodiment of the present invention;

FIG. 4 depicts a high level flow diagram of a process for campaign optimization for the product services analysis and optimization of an embodiment of the present invention; and

FIG. 5 depicts a high level block diagram of an embodiment of a campaign effectiveness control unit suitable for use in the server of the content distribution system of FIG. 1 in accordance with an embodiment the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method, apparatus and system for providing analysis and optimization of product services. Although the present invention will be described primarily within the context of a retail advertising network environment, the specific embodiments of the present invention should not be treated as limiting the scope of the invention. It will be appreciated by those skilled in the art and informed by the teachings of the present invention that the concepts of the present invention can be advantageously applied in substantially any product services environment.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

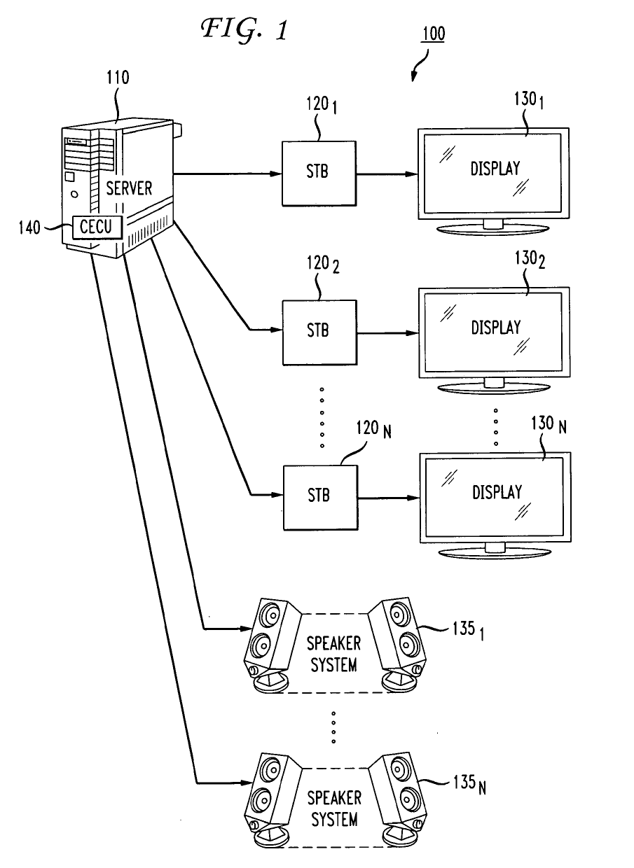

FIG. 1 depicts a high level block diagram of a content distribution system in which an embodiment of the present invention can be applied. The content distribution system 100 of FIG. 1 illustratively comprises at least one server 110, a plurality of receiving devices such as tuning/decoding means (illustratively set-top boxes (STBs)) 120₁-120ₙ, and a respective display 130₁-130ₙ for each of the set-top boxes 120₁-120ₙ, and other receiving devices, such as audio output devices (illustratively speaker systems) 135₁-135ₙ. Although in the system 100 of FIG. 1, each of the plurality of set-top boxes 120₁-120ₙ, is illustratively connected to a single, respective display, in alternate embodiments of the present invention, each of the plurality of set-top boxes 120₁-120ₙ, can be connected to more than a single display. In addition, although in the content distribution system 100 of FIG. 1 the tuning/decoding means are illustratively depicted as set-top boxes 120, in alternate embodiments of the present invention, the tuning/decoding means of the present invention can comprise alternate tuning/decoding means such as a tuning/decoding circuit integrated into the displays 130 or other stand alone tuning/decoding devices and the like. Even further, receiving devices of the present invention can include any devices capable of receiving content such as audio, video and/or audio/video content.

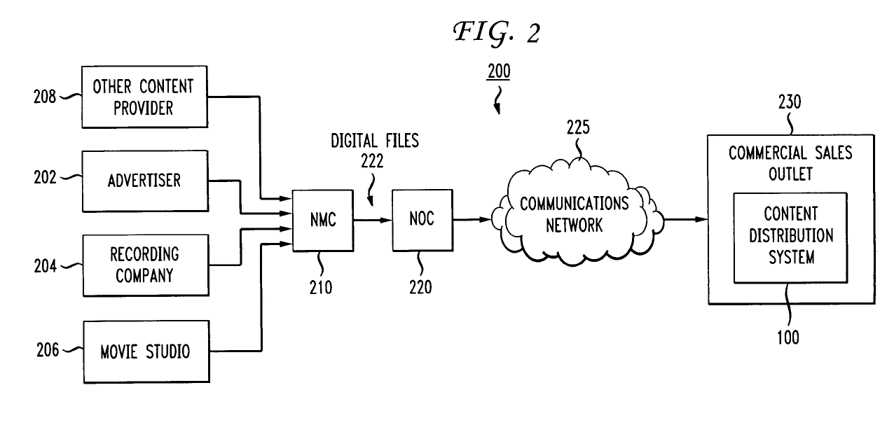

In one embodiment of the present invention, the content distribution system 100 of FIG. 1 can be a part of an in-store advertising network. For example, FIG. 2 depicts a high level block diagram of an in-store advertising network 200 for providing in-store advertising. In the advertising network 200 of FIG. 2, the advertising network 200 and distribution system 100 employ a combination of software and hardware that provides cataloging, distribution, presentation, and usage tracking of music recordings, home video, product demonstrations, advertising content, and other such content, along with entertainment content, news, and similar consumer informational content in an in-store setting. The content can include content presented in compressed or uncompressed video and audio stream format (e.g., MPEG4/MPEG4 Part 10/AVC-H.264, VC-1, Windows Media, etc.), although the present system should not be limited to using only those formats.

In one embodiment of the present invention, software for controlling the various elements of the in-store advertising network 200 and the content distribution system 100 can include a 32-bit operating system using a windowing environment (e.g., MS-Windows™ or X-Windows operating system) and high-performance computing hardware. The advertising network 200 can utilize a distributed architecture and provides centralized content management and distribution control via, in one embodiment, satellite (or other method, e.g., a wide-area network (WAN), the Internet, a series of microwave links, or a similar mechanism) and in-store modules.

As depicted in FIG. 2, the content for the in-store advertising network 200 and the content distribution system 100 can be provided from an advertiser 202, a recording company 204, a movie studio 206 or other content providers 208. An advertiser 202 can be a product manufacturer, a service provider, an advertising company representing a manufacturer or service provider, or other entity. Advertising content from the advertiser 202 can consist of audiovisual content including commercials, “info-mercials”, product information and product demonstrations, and the like.

A recording company 204 can be a record label, music publisher, licensing/publishing entity (e.g., BMI or ASCAP), individual artist, or other such source of music-related content. The recording company 204 provides audiovisual content such as music clips (short segments of recorded music), music video clips, and the like. The movie studio 206 can be a movie studio, a film production company, a publicist, or other source related to the film industry. The movie studio 106 can provide movie clips, pre-recorded interviews with actors and actresses, movie reviews, “behind-the-scenes” presentations, and similar content.

The other content provider 208 can be any other provider of video, audio or audiovisual content that can be distributed and displayed via, for example, the content distribution system 100 of FIG. 1.

In one embodiment of the present invention, content is procured via the network management center 210 (NMC) using, for example, traditional recorded media (tapes, CD's, videos, and the like). Content provided to the NMC 210 is compiled into a form suitable for distribution to, for example, the local distribution system 100, which distributes and displays the content at a local site.

The NMC 210 can digitize the received content and provide it to a Network Operations Center (NOC) 220 in the form of digitized data files 222. It will be noted that data files 222, although referred to in terms of digitized content, can also be streaming audio, streaming video, or other such information. The content compiled and received by the NMC 210 can include commercials, bumpers, graphics, audio and the like. All files are preferably named so that they are uniquely identifiable. More specifically, the NMC 210 creates distribution packs that are targeted to specific sites, such as store locations, and delivered to one or more stores on a scheduled or on-demand basis. The distribution packs, if used, contain content that is intended to either replace or enhance existing content already present on-site (unless the site's system is being initialized for the first time, in which case the packages delivered can form the basis of the site's initial content). Alternatively, the files may be compressed and transferred separately, or a streaming compression program of some type employed.

The NOC 220 communicates digitized data files 222 to, in this example, the content distribution system 100 at a commercial sales outlet 230 via a communications network 225. The communications network 225 can be implemented in any one of several technologies. For example, in one embodiment of the present invention, a satellite link can be used to distribute digitized data files 222 to the content distribution system 100 of the commercial sales outlet 230. This enables content to easily be distributed by broadcasting (or multicasting) the content to various locations. Alternatively, the Internet can be used to both distribute audiovisual content to and allow feedback from commercial sales outlet 230. Other ways of implementing communications network 225, such as using leased lines, a microwave network, or other such mechanisms can also be used in accordance with alternate embodiments of the present invention.

In one embodiment of the present invention, the server 110 of the content distribution system 100 is capable of receiving content (e.g., distribution packs) and, accordingly, distribute them in-store to the various receivers such as the set-top boxes 120 and displays 130 and the speaker systems 135. That is, at the content distribution system 100, content is received and configured for communication. The communication can be performed by one or more servers configured to act together or in concert. The content can include content configured for various different locations or products throughout the sales outlet 230 (e.g., store). For example, respective set-top boxes 120 and displays 130 and various speaker systems 135 can be located at specific locations throughout the sales outlet 230 and respectively configured to display content and broadcast audio pertaining to products located within a predetermined distance from the location of each respective set-top box and display.

The server 110 of the content distribution system 100 receives content and creates various different content channels of audio, video and/or audio/video to be communicated to the various receivers throughout the store. The content channels can be individual channels of modulated audio, video and/or audio/video onto a radio frequency distribution or transmitted as data flows within a unicast or multicast internet protocol (IP) network. These streams can originate from one or more servers under the same logical set of control software.

The various embodiments of the present invention provide a method, apparatus and system for collecting data from various locations throughout, for example the content distribution system 100 of FIG. 1 and the in-store advertising network 200 of FIG. 2, to provide feedback on for example, an advertising campaign.

That is, in one embodiment of the present invention, a campaign is defined as the act of an advertiser deciding upon the scope of a given advertising effort. A campaign can include specifying product(s) and/or service(s) that are to be part of the effort, setting sales goals, and identifying specific target demographics (age group, gender, language, socio-economic class, geographic location, date range, time of day, etc.). The campaign can optionally define multiple media files as alternate ads towards accomplishing the goals of the campaign.

Using the campaign definition, orders are created in an inventory and sales management system. In one embodiment of the present invention, the order process books available inventory (available spots in programs in which ads can be inserted). This reserves the spot and creates a ‘placement’ for each ad. At this point, if the campaign did not already have appropriate media available, then new media must be created.

The media is then scheduled for distribution, which includes the set of functions that delivers the advertising to the target audience. This includes several discrete operations. Media scheduling is the process of translating placements into specific playback instructions (playlists) targeted by the rules specified in the campaign definition. Media packaging is the process of bundling media for delivery over a transport service. Media Transport is the delivery mechanism that moves the media packages from the central Network Operations Center to the location of playback. The Media Playout system renders the actual media to the targeted consumer. This series of operations together is the act of delivering the media to the target.

In accordance with various embodiments of the present invention, data is collected from various locations throughout, for example the content distribution system 100 of FIG. 1 and the in-store advertising network 200 of FIG. 2, and information is determined for qualifying, for example, an advertising campaign. That is, in one embodiment of the present invention, data provided for feedback is used by, for example, an analysis engine, to evaluate the data for qualifying a media campaign, such as an advertising campaign. For example, in one embodiment of the present invention, sales information from a point-of-sale (POS) is compared to a campaign definition (objectives and targeted ad placements) to determine if a campaign was successful. Advertising playout data provides a means to determine if the delivery system was functional. System errors can result in targeted playout objectives not being met. For example, a failed media server in some stores could result in no ads playing in that store. A failed screen in a store would result in no ads playing on that screen. A missing media file in some or all stores would result in that ad not playing for some or all of the campaign. Using the playout data, the effectiveness of, for example, an advertsing system in delivering the campaign is measured. Using those results compared to the change in sales data reflected in the POS data provides a measure of success of the campaign in accomplishing its sales goals.

Optionally, if the campaign definition had defined alternate ads as part of the campaign, then suggestions for altering the media playout and targeting based on the effectiveness analysis can also be provided in accordance with embodiments of the present invention. For example, if a first ad is accomplishing higher sales lift then a second ad, the playing of the first add can be recommend in more locations at more times. This set of recommendations can be provided constantly based on available information in accordance with the present invention.

In accordance with various embodiments of the present invention, campaign reports can be provided, for example, periodically or on demand. The campaign reports summarize the current effectiveness of the delivery system, campaign sales lift, and such. These reports can be made available via a web interface or as files. A “proof of performance report” is also identified. This report is an affidavit that acts as proof that a purchased advertising placement was in fact played in the locations and at the times for which they were paid.

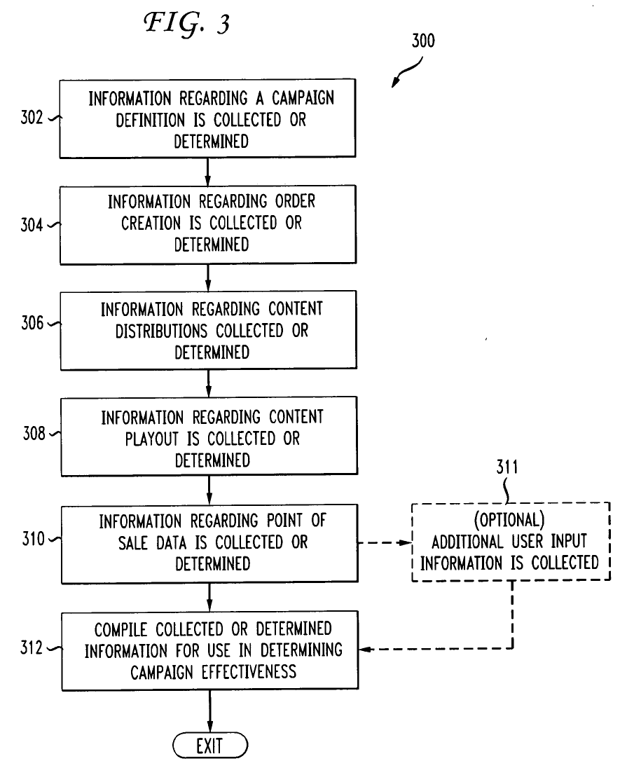

FIG. 3 depicts a high level flow diagram of a method for product services analysis and optimization in accordance with one embodiment of the present invention. The method 300 of FIG. 3 begins at step 302 at which information regarding a defined campaign, such as an advertising campaign, is collected or determined. As previously recited, a campaign definition can be performed by an advertiser and can include the scope of a given media campaign, such as an advertising effort. The method 300 then proceeds to step 304.

At step 304, information regarding order creation is collected or determined. As previously recited, order creation can include booking available spots in programs in which media content, such as ads, can be inserted. This reserves the spot and creates a ‘placement’ for each media content. The method then proceeds to step 306.

At step 306, information regarding content distribution is collected or determined. As previously recited, content distribution can include media scheduling, media packaging and media transport. For example, media scheduling can include the process of translating placements into specific playback instructions (playlists) targeted by the rules specified in the campaign definition. Media packaging can include the process of bundling media for delivery over a transport service. Media Transport can include the delivery mechanism that moves the media packages from, for example the Network Operations Center 220 of FIG. 2, to the location of playback, for example the STB 120 and respective display 130 and the speaker 135 of the content distribution system 100 of FIG. 1. The method then proceeds to step 308.

At step 308, information regarding content (media) playout is collected or determined. Media playout can include presenting the actual media content to, for example, a targeted consumer or audience. For example, it is typical in media content playout environments for a playout log to be maintained to keep a record of what media content was actually played on playout systems. The method then proceeds to step 310.

At step 310, information regarding point of sale data is collected or determined. That is, data regarding product sales or services during the time of the defined campaign is collected and or determined. That is, actual point of sale (POS) data can be collected from, for example, a retailer, for products defined in the campaign. The method can then optionally proceed to step 311 or can proceed directly to step 312.

At optional step 311, additional user input information can be collected. For example, in various embodiments of the present invention, a user can be enabled to input information including, for example, in store interviews and surveys to be collected for use in the product services analysis and optimization of the present invention. The method then proceeds to step 312.

At step 312, the collected or determined information described in the previous method steps is compiled such that the campaign information can be used to determine campaign effectiveness. For example, in one embodiment of the present invention, a campaign effectiveness control unit (CECU) 140 includes a memory for storing information regarding at least a definition of a media content campaign and performance information of the media content campaign as described above and a processor for collecting the information regarding at least a definition of a media content campaign and a performance of the media content campaign and compiling the collected information for analysis. In an alternate embodiment of the present invention, the collected or determined information is used by the CECU 140, which includes a processor (e.g., an analysis engine), for enabling determining campaign effectiveness (as further described below), which can be used for determining improvements that can be made to a media campaign, such as an advertising campaign (as further described below). The method 300 can then be exited.

For example, in one embodiment of the present invention, the server 110 of the content distribution system 100 of FIG. 1 can include a CECU 140 for performing the method 300 of FIG. 3. That is, the CECU 140 of the server 110 of FIG. 1 can collect or determine the necessary information to be used in the above described product services analysis and optimization method of the present invention. In addition, a user interface (not shown) can be in communication with the CECU 140 of the server 110 for communicating user information (as described above) to the CECU 140 of the server 110. The information collected or determined can be stored in an included memory of the CECU 140 of the server 110 or can be stored in a separate memory location (not shown). In addition, in such an embodiment of the present invention, the CECU 140 of the server 110 can include a processor for analyzing the collected or determined information for determining the effectiveness of a media campaign, such as an advertising campaign, which can be used for determining improvements that can be made to a media campaign. That is, as described above and in accordance with various embodiments of the present invention, information regarding such campaign processes such as order creation, content distribution, content playout, point of sale data and campaign definition is collected and/or determined and ultimately compiled and provided to, for example the CECU 140 of the server 110, for analysis such that it can be determined if a media campaign was successfully performed as defined. Although in the content distribution system 100 of FIG. 1, the CECU 140 is illustratively depicted as being incorporated into the server 110, in alternate embodiments of the present invention, a CECU of the present invention can be a stand-alone component.

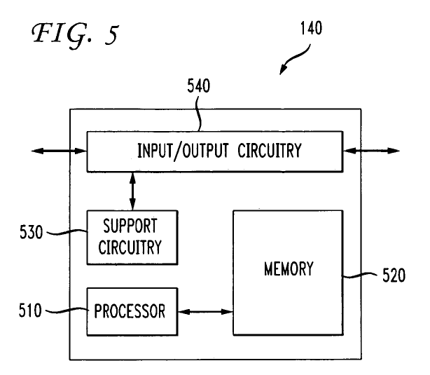

FIG. 5 depicts a high level block diagram of an embodiment of a CECU 140 suitable for use in the server 110 of the content distribution system 100 of FIG. 1 in accordance with an embodiment the present invention. The CECU 140 of FIG. 5 illustratively comprises a processor 510 as well as a memory 520 for storing collected information, media content and the like. The processor 510 cooperates with conventional support circuitry 530 such as power supplies, clock circuits, cache memory and the like as well as circuits. As such, it is contemplated that some of the process steps discussed herein as software processes can be implemented within hardware, for example, as circuitry that cooperates with the processor 510 to perform various steps. The CECU 140 also contains input-output circuitry 540 that forms an interface between the various respective functional elements such as the server 110.

Although the CECU 140 of FIG. 5 is depicted as a general purpose computer that is programmed to perform various control functions in accordance with the present invention, the invention can be implemented in hardware, for example, as an application specified integrated circuit (ASIC). As such, the process steps described herein are intended to be broadly interpreted as being equivalently performed by software, hardware, or a combination thereof.

In alternate embodiments of the present invention, a CECU of the present invention can be included in the network management center 210 or the Network Operations Center (NOC) 220 of the in-store advertising network 200 of FIG. 2 for collecting or determining the above described information to be used in the above described product services analysis and optimization method of the present invention.

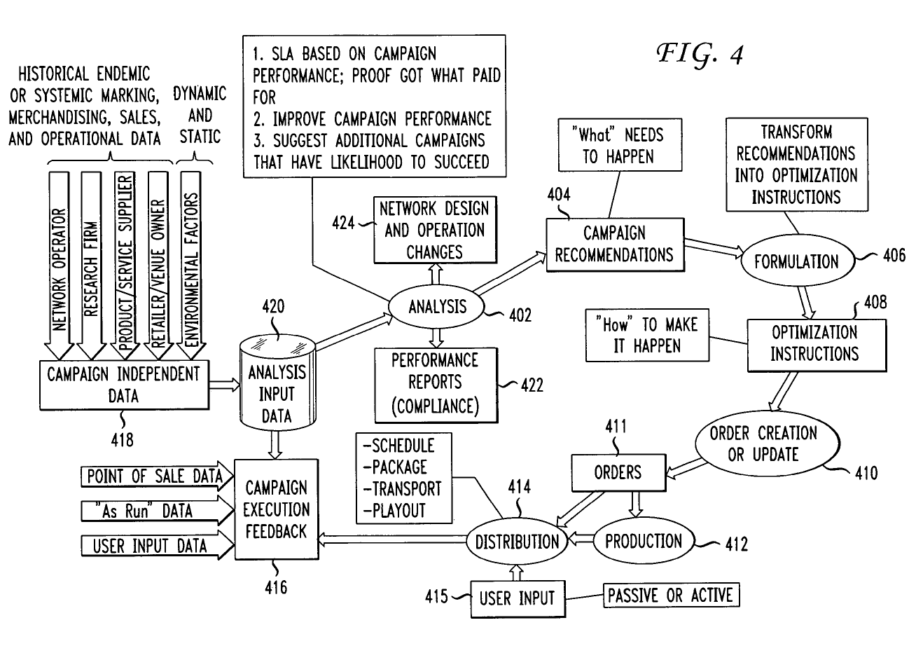

FIG. 4 depicts a high level flow diagram of a process for campaign optimization for the product services analysis and optimization of an embodiment of the present invention. In the embodiment of FIG. 4, a customer provides a system of the present invention with historical, systemic or endemic marketing, merchandising, sales, and operational data about the intended products or services to be advertised & promoted in the campaign. The system combines this with other campaign independent data and performs analysis that results in a recommendation (or set of recommendations) on what is needed to effectively execute the campaign (in FIG. 4: Analysis 402). In the embodiment of FIG. 4, these or any subsequent recommendations (in FIG. 4: Campaign Recommendations 404) includes coverage of at least the following characteristics:
1. creative and programming
2. targeting (where and who)
3. channel(s) and network(s)
4. interactive methods
5. product(s) and/or bundling
6. times, dates, and frequency
7. product availability
8. presentation configuration, such as a digital configuration, which includes audio state, video contrast or aspect ratio, media format, monitor angle or orientation, device location, and other environmental factors at the presentation location or signage configuration, which includes sign positioning, orientation, size or angle, or configurations for other electronic or non-electronic systems.

A formulation process (in FIG. 4: Formulation 406) is then performed on the recommendation to derive and produce the appropriate optimization instructions (in FIG. 4: Optimization Instructions 408), which define how to fulfill the recommendations. These optimizations instructions are then used to create an initial order (or set of orders) for the system (in FIG. 4: Order Creation or Update 410 and Orders 411).

Alternatively, a customer can directly place an order (or set of orders) for the system without an initial analysis for optimizing the start of the campaign. The customer may have internal knowledge of the products or services that permit an adequate initial estimate of the best campaign characteristics to be made.

### Order Execution

Once the order or orders are created, the system begins to execute the orders. Execution requires the media for the campaign to be created (in FIG. 4: Production 412) and encoded in the proper format for distribution. Once the media exists, then distribution of the media starts (in FIG. 4: Distribution 414). Distribution requires the system to first schedule the playout of the media for the specified date, times and frequency at the required locations, which includes region, locale, site, department, or presentation point of presence, on the various networks and channels specified in the orders. For digital media, the system then packages the media and the scheduling information together and distributes it to the appropriate playout locations at the proper time. For signage media, the media is printed, shipped and installed at the presentation location at the proper time. Once the specified playout or presentation locations have the media, then the media is presented to the specified consumer or consumers (or shoppers in a retail location) on the specified dates at the specified times and frequency and in the specified context and format.

While the media associated with the campaign is being presented to the specified consumer, the system collects information specific to the campaign execution (in FIG. 4: Campaign Execution Feedback 416). Campaign execution data includes point of sale (POS) data reflecting the sales of the product or service, sales within the related product or service category, or sales of related cross-category products or services around the time the media is being presented, “as run” data representing the specific date and times the media was exposed to the consumer at each playout location and media presentation point of presence, any simultaneous or related promotional efforts for the product or service, related product or service category, or related cross-category products or services, and user input data (in FIG. 4: User Input 415) provided either passively, such as via RFID-based loyalty cards in possession of the user, RFID-based product identification information to products in a shopping cart, venue location information collected from a cart or device in possession of the user or camera-based viewer detection systems, or actively, such as UPC scanned with a barcode scanner, a sequence of menu selections from a touch screen display proximate to the media display, or an electronic record of human to human or human to machine interaction.

Concurrent with the distribution of the media, the system collects either continuously or on a periodic basis historical, systemic, or endemic campaign independent information from appropriate owners or holders of useful information, such as the product or service supplier, the retailer or venue owner, research firms, or the network operator (in FIG. 4: Campaign Independent Data 418). The campaign independent data is related to marketing, merchandising, sales and operations, which includes previous or other campaign recommendations, promotional efforts and results, or dynamic or static environmental factors, such as weather, earthquakes, community events, national events, such as elections or the Super Bowl, or global events that have local impact. The system collects and stores the campaign independent data along with the campaign execution feedback for input into the analysis process (in FIG. 4: Analysis Input Data 420). On a continuous or periodic basis, the system performs analyses of the input data (in FIG. 4: Analysis 402), both campaign independent data and campaign execution feedback, to a) evaluate the performance of the campaign: did the campaign execution accomplish the customer's objectives (in FIG. 4: Performance Reports (Compliance) 422), b) determine recommendations to improve the existing campaign's performance and/or for additional or alternative campaigns (in FIG. 4: Campaign Recommendations 404), and c) specify changes to the network design or operations to improve performance all applicable campaigns (in FIG. 4: Network Design & Operation Changes 424).

The campaign improvement or additional campaign recommendations (in FIG. 4: Campaign Recommendations 404) includes coverage of at least the following campaign characteristics in accordance with one embodiment of the present invention:
1. creative and programming
2. targeting (where and who)
3. channel(s) and network(s)
4. interactive methods
5. product(s) and/or bundling
6. times, dates, and frequency
7. product availability
8. presentation configuration, such as a digital configuration, which includes such as audio state, video contrast or aspect ratio, media format, monitor angle or orientation, device location, and other environmental factors at the presentation location or signage configuration, which includes sign positioning, orientation, size or angle, or configurations for other electronic or non-electronic systems.

### Performance Report

Based on the analysis the system generates a performance report available for interested parties, which includes the customer, the product or service supplier, network operator, or the retailer or venue owner. The performance report specifies how effective the system's operation was to meeting the campaign requirements defined in the orders; therefore, did the campaign execution comply with the orders.

### Optimize Existing Order

The recommendations created by the analysis process can indicate the existing campaign would benefit from changes to one or more of the campaign characteristics listed above. A formulation process (in FIG. 4: Formulation 406) then creates optimization instructions from the recommendations. Optimization instructions define how the system must execute recommendations. These instructions define what changes are required to the existing orders so that the campaign recommendations can be executed. When the formulation process generates optimization instructions for existing orders, then depending on their varying degrees of complexity, the system could rework the existing orders or terminate the existing orders and replace them with new orders.

When the optimization instructions only require rework of the order, then the system, with or without the explicit approval of the customer, product or service supplier, network operator, or venue owner, can modify the order (in FIG. 4: Order Creation or Update 410) and either start the production process on the modified orders, start the distribution process on the modified orders, or possibly both. In one embodiment, implicit approval can exist from explicit permission granted. Once either the production or distribution process is started, the same operations as described in the Order Execution section above can be performed on the updated orders. Production on updated orders typically involves simple or minor post-production modification to the existing media, versus the creation of new media.

When the optimization instructions require more than a simple rework of the order, for example, a new set of media based on new creative requirements are required, then the existing orders can be terminated and abandoned and new orders based on the optimization instructions can be generated (in FIG. 4: Order Creation or Update 410). These orders can then be passed into the production process and then onto the distribution process for order execution. Once the order creation process is started, the same operations as described in the Order Execution section above can be performed on the replacement orders.

Of course, the customer or the network operator at any time can consider the campaign sufficiently executed, typically based on the order, product availability, elapsed time and the performance reports, and not reissue or approve updated orders or new orders for the campaign. Consequently, for the given campaign, the overall optimization process can be stopped.

### Additional or Alternate Orders

Alternately, the recommendations created by the analysis process can indicate an additional or an alternate campaign that would be beneficial to execute with the campaign characteristics listed above in the Order Execution section. Optimization instructions for these recommendations can be generated and can address the complete set of campaign characteristics, similar to the instructions for the initial orders. These recommendations and instructions can be focused on alternate or additional campaigns for the same products and services, or can also be focused on completely different products or services or an alternate bundling of products and/or services. In addition, these alternate or additional recommendations can include advertising or promoting on other electronic or non-electronic mediums.

In essence, these new optimization instructions can generate initial orders for these other campaigns, similar to the customer's initial orders that started this process. Once the optimization instructions have been created, the operations performed can be similar to the ones performed for the initial orders after their optimization instructions were created.

### Network Design and Operation Changes

Periodically, the analysis process can discover changes that would improve performance across campaigns, or for many or most campaigns. Typically, these changes require modifications to the network or its operation that cannot be performed on a single campaign basis, but requires new configurations, equipment, or services that must be in place before any campaign can utilize the changes. The changes, such as additional venues to utilize as playout locations, additional of presentations points of presence (where signage or displays and speakers are located at a venue), presentation points of presence that are no longer effective or utilized, or configurations of the playout systems that would better present the media, can be recommended to the network operator (in FIG. 4: Network Design and Operation Changes) when discovered.

For example, the following depicts an example of a specific campaign optimization scope and functions and data to be applied in accordance with one embodiment of the present invention.

Campaign Optimization Scope
1. Sales Lift: optimize sales impact of media campaign
2. shopper experience
3. merchandise optimization (forecast input)

Functions within Campaign Optimization
1. Target Optimization
   a. Which media works best with what people (who) at which locations (where)
   b. “works best”: generating highest rate of sales
   c. Who attributes
      1) demos
      2) age
      3) gender
      4) ethnicity
      5) language
      6) psychographics
   d. Where attributes
      1) Country
      2) Region
      3) Locale
      4) Store
      5) Department/channel/screen
   e. Calculate sales rate for each of these “where” (location) attributes
2. Product Availability Synch with Media
   a. Play the “optimum” media for the “proximate” product
      1) Media that is “related”. It must not be counter to the product.
      2) Relationship is from the specific to the generic
      3) Proximate to the point of presentation of the media
      4) Key is forecasting when and where product will be available.
   b. Media related to product [specific to generic, but “related”]
      1) Specific product spot
      2) Brand ad
      3) Supplier ad
      4) Category ad
      5) Retailer ad
      6) Generic spot that is independent of any product [Evergreen type content]
   c. Merchandise planning and allocation value
      1) Key to product location forecasting
      2) Defines to retailer and PRN:
         a) What is the product
         b) How much do we have
         c) How is the product allocated across the chain, region, district, store
         d) Where in store is it and how is it to be merchandised: end cap with video, end cap with sign, in aisle, in back room, tied to a promotion?
   d. Forecasting when product might be available or unavailable
      1) Availability plus N days
      2) N days: time required for PRN to execute through the media supply chain: media production, programming/scheduling, and distribution requirements.
      3) Based on sell-through rate, something the retailer is already doing
         a) Get results and relate it to the media supply chain.
      4) Most specific media to playout up to day run out, then alternate for day (or so) when out of stock (below minimum) while ordering from distribution center and play alternate media (e.g. brand ad), then when product shows up return to playing most specific media to product.
   e. What is merchandise planning and allocation
      1) Ordering products (initial, refill, end of life)
      2) Forecasting demand (sales, seasonality, promotions, . . . )
      3) Allocating units to stores
         a) Across chain, region, district, or single stores (testing)
      4) Pricing
      5) Assortment (combinations and variations [size, color, . . . ] of products needed in different markets)
         a) E.g. Asian community needs smaller shirt size assortment
      6) Systems used for these processes must provide inputs to media supply chain
   f. Promotional planning
      1) Sometimes part of merchandise planning and allocation group, sometimes a separate group
      2) Work with consumer product goods companies (CPG)
      3) Decide which products to promote and where and when
      4) Decide how to promote the product
      5) Sends notice to merchants to plan and allocate for promotion
   g. Product characteristics
      1) Number of units at that display is key
      2) Defined for each product: the optimum number of units that should be at display and possibly a minimum number of units at the display for some period of time (probably daily)
      3) What other is available:
         a) Aisle
         b) Other display
         c) Back room
         d) In transit shipped from manufacturer/supplier or shipped from distribution center (DC)
         e) On order from DC to store OR to DC. On order for store, sends request to a DC. New order needs processing by CPG and none in DC
3. Creative/copy Optimization
   a. Which combination of creative elements are generating the highest rate of sales for a given target (see Where attributes in Target Optimization above).
      1) Less specific alternative: Which combination of creative elements work best with the people and locations targeted.
   b. Attributes of creative elements (not necessarily a complete list)
      1) Color
      2) Objects
      3) Text
      4) Audio
      5) People
      6) Music
      7) Angles
   c. AB testing
      1) Static media testing. A fixed set of media for the campaign is created beforehand
      2) The set of media has a well-defined set of element variation between them.
   d. Multivariate testing
      1) For multivariate need to compare creative elements, not just whole pieces of media
      2) Dynamic linkage of elements at playout time
      3) Playout time composition with video and overlay media.
         a) How is this accomplished in an IPTV context?
4. Time/Daypart Optimization
   a. Which media works best on which times, on which dates and at what frequency.
   b.
   c. Attributes
      1) Loop
      2) Frequency
      3) Seasons
      4) Time of day
      5) Day of week
      6) Special events—planned, controlled. E.g. All-star game
      7) Exogenis factors—out of control of the network operations or retail operations and unpredictable. E.g. weather, earthquake, natural disaster

Data
1. POS data
2. play logs
3. expected play information (includes rundown, targets, sites, placements, orders, customer)
4. availability of A/V component data (e.g. screens or speakers operational)
5. Output of retailer's merchandise planning and allocation systems
   a. Product attributes
   b. Inventory attributes
   c. Transportation attributes
6. product information
   a. forecast of inventory and timing of inventory
   b. product characteristics—e.g. pack-out, capacity
7. Store planning data
   a. shopper traffic data
   b. floor merchandising capacity
   c. capacity at site

Function to Solution
1. portal
2. Compare sales data to playout data on time and/or location basis
3. use expected data and validate with play logs/availability information

Media played [symbol] number of exposures within period Sales impact within a range of time after exposure
Acceptable period after exposure where we can measure impact
PRISM—How do impressions strengthen optimization?

Roadmap

Create functionality/solutions in the following order with the defined basic capabilities.
1. non-systemic process around getting retailer merchandising planning and allocation data and retailer shopper traffic data integrated into a media planning, production, distribution, and playout solution around DemoVision.
2. Target optimization
   a. media variation in a single campaign period used in splits
   b. POS data from retailer
   c. Playout as run data
   d. Determine which of concurrently running spots is having a higher rate of sales by location and time
   e. Change placements of media so more successful spots are running in areas where other spots were unsuccessful
   f. Schedule placements and transmit to sites for playout. Requires media to be broadly distributed, but have updated playlists distributed to get playout change.
   g. Will require Dayparts and Time of Day functionality in systems
      Providing Data to retailer based on Interactivity (e.g. TV wall interactive)
1. Shopper understands what they need to make HDTV work from content in program guide
2. Retailer learns of bundling opportunity based on what shoppers is looking at
3. HDMI cable, a special remote, a subscription to an HDTV service
4. Offers are made based on user input and navigation
   How does campaign affect price, bundles and promotions?

Data out to Retailer allows the retailer to make decisions on:
1. Pricing
2. Shopping experience
3. Promotions
4. Presence

How does this fit?
1. Behavioral targeting
   a. Behavioral merchandise “Bucket”
   b. User input (could be “passive”) based feedback to playlist/target
2. Behavioral network design
3. Behavioral media design
   Marketing/messaging creative.

Having described various embodiments for a method, apparatus and system for providing analysis and optimization of product services (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

1. A method in a content distribution system comprising the steps of:
collecting information regarding at least a definition of a media content campaign and a performance of the media content campaign; and
compiling said collected information for analysis;
wherein said analysis determines the effectiveness of the media content campaign.

2. The method of claim 1, wherein said performance information includes information regarding at least one of an order creation, content distribution, content playout and point of sale data.

3. The method of claim 2, wherein said content distribution information includes information regarding at least one of media scheduling, media packaging and media transport.

4. The method of claim 1, wherein said information includes user input information.

5. The method of claim 4, wherein said user input information includes information regarding results of interviews and surveys.

6. The method of claim 1, wherein said analysis includes:
evaluating intrinsic information regarding at least one of content and services to be delivered;
evaluating extrinsic information and services delivery data; and
performing an analysis using said intrinsic and extrinsic information to determine optimization parameters for said content distribution system.

7. The method of claim 6, wherein said intrinsic information comprises at least one of historical, systemic and endemic marketing, merchandising, sales, and operational data.

8. The method of claim 6, wherein said extrinsic information comprises at least one of customer and site demographics.

9. The method of claim 1, wherein said media content campaign comprises an advertising campaign.

10. The method of claim 1, further comprising using the results of the analysis to provide a recommendation on campaign changes needed to be made to perform an effective execution of the media content campaign.

11. An apparatus, comprising:
a memory for storing information regarding at least a definition of a media content campaign and performance information of the media content campaign in a content distribution system; and
a processor for collecting said information regarding at least a definition of a media content campaign and a performance of the media content campaign and compiling said collected information for analysis.

12. The apparatus of claim 11, wherein said processor further analyzes the compiled information to determine an effectiveness of the media content campaign.

13. The apparatus of claim 12, wherein said analysis includes:
evaluating intrinsic information regarding at least one of content and services to be delivered;
evaluating extrinsic information and services delivery data; and
performing an analysis using said intrinsic and extrinsic information to determine optimization parameters for said content distribution system.

14. The apparatus of claim 11, wherein said performance information includes information regarding at least one of an order creation, content distribution, content playout and point of sale data for the media content.

15. The method of claim 14, wherein said content distribution information includes information regarding at least one of media scheduling, media packaging and media transport for the media content.

16. The apparatus of claim 11, wherein said processor further uses the results of the analysis to provide a recommendation on campaign changes needed to be made to perform an effective execution of the media content campaign.

17. A system, comprising:
at least one source of media content;
at least one means for receiving a media content campaign definition; and
a content distribution system including at least an apparatus, comprising:
a memory for storing information regarding at least a definition of the media content campaign and performance information of the media content campaign in the content distribution system; and
a processor for collecting said information regarding at least a definition of a media content campaign and a performance of the media content campaign and compiling said collected information for analysis.

18. The system of claim 17, wherein said processor further analyzes the compiled information to determine an effectiveness of the media content campaign in the content distribution system.
